(19) United States
(12) Patent Application Publication
(10) Pub. No.: US 2016/0246537 A1
(43) Pub. Date: Aug. 25, 2016

(54) DEDUPLICATION OF PARITY DATA IN SSD BASED RAID SYSTEMS

(71) Applicant: INHA-INDUSTRY PARTNERSHIP INSTITUTE, Incheon, IN (KR)

(72) Inventor: Deok-Hwan Kim, Seoul (KR)

(73) Assignee: INHA-INDUSTRY PARTNERSHIP INSTITUTE, Incheon, IN (KR)

(21) Appl. No.: 15/023,068

(22) PCT Filed: Sep. 27, 2013
(86) PCT No.: PCT/KR2013/008690

§ 371 Date: Mar. 18, 2016

(51) Int. Cl. G06F 3/06; G06F 11/10

(52) U.S. Cl. CPC G06F 3/0641; G06F 11/1076; G06F 3/0619; G06F 3/0659; G06F 3/0689

(57) ABSTRACT

The present disclosure describes various techniques related to maintaining parity data in a redundant array of independent disks (RAID).

### BACKGROUND

In some computing applications, multiple storage devices (e.g., mechanical storage devices, solid-state drive (SSD) devices, or the like) may be configured to act as a single logical storage device. Such a configuration may be referred to as a redundant array of independent disks (RAID). Various RAID configurations may provide some level of fault tolerance using an error protection scheme referred to as “parity.” In general, RAID configurations that use parity may generate parity data corresponding to the data stored in the RAID and store the parity data in a parity portion of the RAID. The parity data may later be used to recover from errors (e.g., data corruption, drive failure, or the like) affecting the data stored in the RAID. However, in order to maintain fault tolerance, each time new data is written to the RAID, the parity data may need to be regenerated and re-written to the parity portion of the RAID. In the case of RAID configurations that store the parity data on an SSD device, continually re-writing the parity data to the RAID may cause increased wear of the SSD and/or increased power consumption by the RAID.

### SUMMARY

Detailed herein are various illustrative methods to maintain parity data in a RAID, which may be embodied as any variety of methods, apparatus, systems and/or computer program products.

Some example methods may include at a RAID control module, receiving a request to write a unit of data to a data storage portion of the RAID that has a current unit of data stored in the data storage portion and has current parity data stored in a parity data storage portion of the RAID, determining, in response to the request to write the unit of data, temporary data based at least in part upon an exclusive-or (XOR) between the unit of data and the current unit of data, determining new parity data based at least in part upon an XOR operation between the temporary data and the current parity data, de-duplicating the new parity data to determine whether any portions of the new parity data are duplicates of portions of the current parity data, and writing the portions of the new parity data determined to not be duplicates of the portions of the current parity data to the parity data storage portion of the RAID.

The present disclosure also describes various example machine-readable non-transitory storage medium having stored therein instructions that, in response to execution by one or more processors, operatively enable a redundant array of independent disks (RAID) control module of the RAID to determine, in response to a request to write a particular unit of data to the RAID that may have a data storage portion associated with a first unit of data and the RAID has a parity data storage portion associated with first parity data, temporary data based at least in part upon an exclusive-or (XOR) operation between the particular unit of data and the first unit of data, determine second parity data based at least in part upon an XOR operation between the temporary data and the first parity data, de-duplicate the second parity data to determine whether any portions of the second parity data are duplicates of portions of the first parity data, and write the portions of the second parity data determined to not be duplicates of the portions of the first parity data to the parity data storage portion of the RAID.

The disclosure additionally describes example systems that may include a redundant array of independent disks (RAID) that has a current unit of data stored in the data storage portion and has current parity data stored in a parity data storage portion of the RAID and a RAID control module communicatively coupled to the RAID. In an example, the RAID control module comprises a data input/output module capable of being operatively enable to receive a request to write a unit of data to the data storage portion of the RAID, the RAID module also may comprise a parity maintenance module configured to compare, in response to the request to write the unit of data, the unit of data and the current parity data to identify temporary parity data, compare the temporary parity data and the current parity data to identify new parity data, split the new parity data into a plurality of new parity data chunks, build a hash table associating each of a plurality of first hash values with different ones of the new parity data chunks and associating each of a plurality of second hash values with different ones of chunks of the current parity data, and identify a non-duplicative chunk of the new parity data comprising at least a first portion of the unit of data based on a comparison of the plurality of first hash values with the plurality of second hash values.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure, and are therefore, not to be considered limiting of its scope. The disclosure will be described with additional specificity and detail through use of the accompanying drawings.

In the drawings:

FIG. 1A illustrates a block diagram of an example system including a RAID;

FIG. 1B illustrates a block diagram of example current parity data and chunks of the current parity data;

FIG. 1C illustrates a block diagram of an example hash table;

FIG. 2A illustrates a block diagram of an example system including a RAID;

FIG. 2B illustrates a block diagram of example new parity data and chunks of the new parity data;

FIG. 2C illustrates a block diagram of example hash values corresponding to chunks of the new parity data;

FIG. 2D illustrates a block diagram of an example de-duplication of parity data;

FIG. 2E illustrates a block diagram of an example of an updated hash table based on de-duplicating parity data;

FIG. 3 illustrates a flow chart of an example method to maintain parity data for a RAID;

FIG. 4 illustrates an example computer program product;

FIG. 5 illustrates a block diagram of an example computing device, all arranged in accordance with at least some embodiments of the present disclosure.

### DETAILED DESCRIPTION

The following description sets forth various examples along with specific details to provide a thorough understanding of claimed subject matter. Claimed subject matter might be practiced without some or more of the specific details disclosed herein. Further, in some circumstances, well-known methods, procedures, systems, components and/or circuits have not been described in detail in order to avoid unnecessarily obscuring claimed subject matter. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. The aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to methods, apparatus, systems, and/or computer program products related to maintaining parity data for a RAID.

In general, RAID devices may be comprised of multiple storage devices configured to act as a single logical storage unit. In general, a RAID device may be comprised of two or more individual storage devices and organized in a variety of configurations (e.g., RAID 1, RAID 2, RAID 3, RAID 4, RAID 5, RAID 6, RAID 10, or the like). Various RAID configurations may provide some level of fault tolerance. For example, the parity error protection scheme mentioned above may be implemented in some RAID configurations (e.g., RAID 2, RAID 3, RAID4, RAID5, RAID6, RAID 10, or the like).

In general, the parity error protection scheme may provide fault tolerance by determining parity data from the data stored in the RAID. The parity data may later be used to recover from errors (e.g., data corruption, drive failure, or the like) affecting the data stored in the RAID. As an example, a RAID device may be comprised of first, second, and third individual storage devices. The RAID device may be configured to store data on the first and the second individual storage devices, and store parity data on the third individual storage device. The RAID device may generate the parity data based on an exclusive-or (XOR) operation between the data stored on the first individual storage device and the data stored on the second individual storage device. The RAID device may store this determined parity data to the third individual storage device. The RAID device may then “recover” data stored on the first individual storage device or the second individual storage device using the parity data stored on the third individual storage device. For example, assume that the first individual storage device failed. The data stored on the first individual storage device may be recovered based on an XOR operation between the data stored on the second individual storage device and the parity data stored on the third individual storage device.

In order to maintain fault tolerance, the parity data may need to be continually regenerated and stored in the RAID device. More particularly, when new data is written (or a change in existing data is made) to the RAID device, the parity data may need to be regenerated. For example, using the RAID configuration described above, if the data stored on the first individual storage device changed, the parity data stored on the third individual storage device may no longer be usable to recover the data stored on either the first individual storage device or the second individual storage device. As such, new parity data may need to be determined (e.g., based on an XOR operation between the changed data stored on the first individual storage device and the data stored on the second individual storage device). This new parity data may be written to the third individual storage device, as described above.

For RAID devices that use Solid-state Storage Devices (SSDs) to store their parity data, continually or otherwise writing new parity data to the RAID device multiple times may cause an increased wear in the SSD used to store the parity data. Additionally, the amount of power used to operate the RAID device may be increased due to the need to erase data on an SSD before new data can be written (or existing data changed) and due to the frequent manner in which large amounts of parity data may be written to the SSD.

Various embodiments of the present disclosure may provide for the maintenance of parity data in a RAID device. In particular, some embodiments of the present disclosure may facilitate maintaining parity data where at least some of the parity data may not need to be rewritten to the RAID device each time a change in the data stored in the RAID device is made.

The following non-limiting example, using the configuration described above, is provided to further illustrate some embodiments of the present disclosure. As stated above, the first and second individual storage devices may be used to store data while the third individual storage device may be used to store parity data. As part of storing parity data in the RAID device, the parity data may be split into smaller pieces (chunks) and a hash of each chunk may be generated.

In an example, data in the first and second individual storage devices may be organized into pages. The pages may have a particular size. The chunks of the parity data may be split into various sizes, for example, one or more chunks may be of a first size which may be substantially similar to the pages of data in the first and second individual storage devices. In an example, one or more chunks may have a second size that is less than or equal to the first size, such as for example 4 kilobytes. A hash table may be used to store the hashes and record the location (e.g., memory address, or the like) where the data corresponding to each chunk is stored on the third individual storage device.

When new data is written to the RAID device, new parity data may be determined as follows: determine temporary data based on an XOR operation between the new data and the current data; and determine new parity data based on an XOR operation between the temporary data and the current parity data. For example, assume that new data is written to the first individual storage device. Temporary data may be determined based on an XOR operation between the new data (e.g., data now stored on the first individual storage device) and the current data (e.g., data stored on the second individual storage device). New parity data may then be determined based on an XOR operation between the temporary data and the current parity data (e.g., the parity data stored on the third individual storage device).

The new parity data may be “de-duplicated”, in part, to identify portions of the new parity data that are different than portions of the current parity data. Portions of the new parity data that are identified to be different than the current parity data may be written to the third individual storage device. However, portions of the new parity data that are the same as portions of the current parity data may not need to be rewritten to the third individual storage device. An example de-duplication process may include splitting the new parity data into chunks (e.g., as described above in relation to the current parity data). Hashes may be generated for each chunk of the new parity data and compared to the hashes of the current parity data stored in the hash table. Based on the comparison, any chunks of the new parity data that are found to correspond to a chunk of the current parity data may not need to be written to the third individual storage device. Chunks of the new parity data that are found, based on the comparison, to not correspond to any chunks of the current parity data may be written to the third individual storage device. The hash table may also be updated accordingly (e.g., hashes updated, locations updated, or the like).

As such, the parity data in a RAID device may be maintained (e.g., kept up to date based on up to date stored data in the RAID device) where portions (e.g., chunks) of the new parity data may not need to be re-written to the third individual storage device each time that new parity data is generated. This may result in a reduction in the amount of parity data written to the RAID device each time that new parity data is determined. Accordingly, a substantial reduction in the wear of SSDs used to store parity data may be realized. Furthermore, a substantial reduction in the amount of power consumed by the RAID device may be realized.

The above examples are given for illustrative purposes only and are not intended to be limiting. Particularly, the above examples may be applicable to RAID configurations that include more than three individual storage devices. Furthermore, the above examples may be applicable to RAID configurations that mirror data between storage devices, write data to storage devices based on striping, and/or a combination of the two and/or other configurations. Additionally, various examples of the present disclosure may refer to solid-state storage, solid-state storage devices, and SSDs and/or other types of storage devices. At least some embodiments described herein may use various types of solid-state technology (e.g., Flash, DRAM, phase-change memory, resistive RAM, ferroelectric RAM, nano-RAM, or the like). Furthermore, at least some embodiments may be applicable to multi-element storage arrays where one or more of the elements may be non-SSD type storage devices. For example, with some embodiments, a RAID array may be comprised of a combination of spinning disk storage and SSD storage.

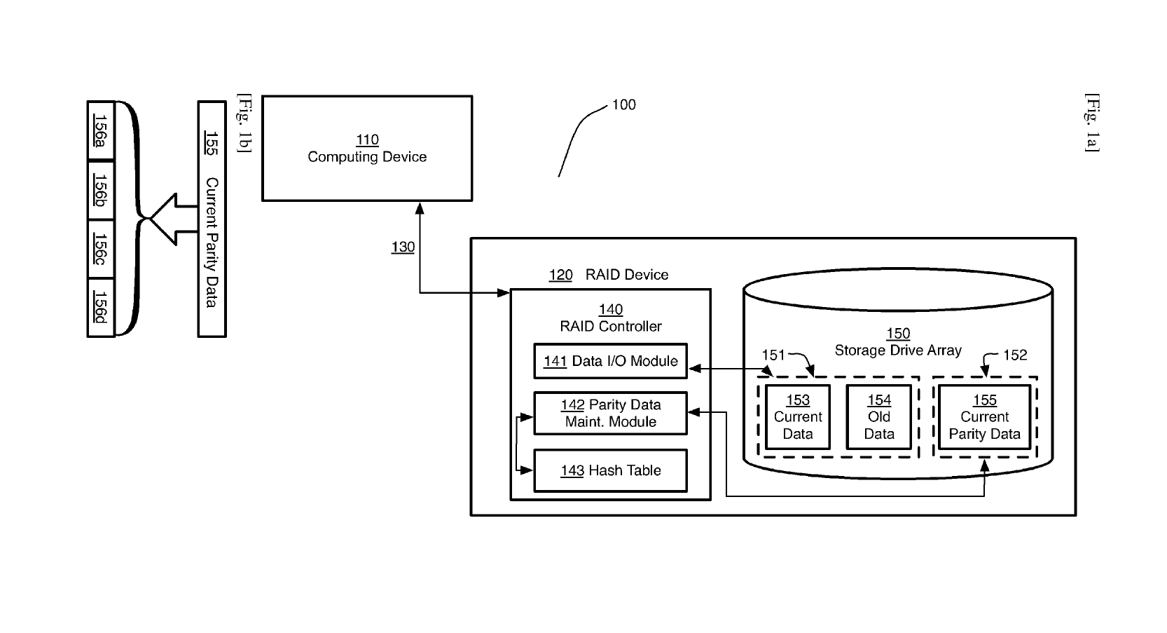

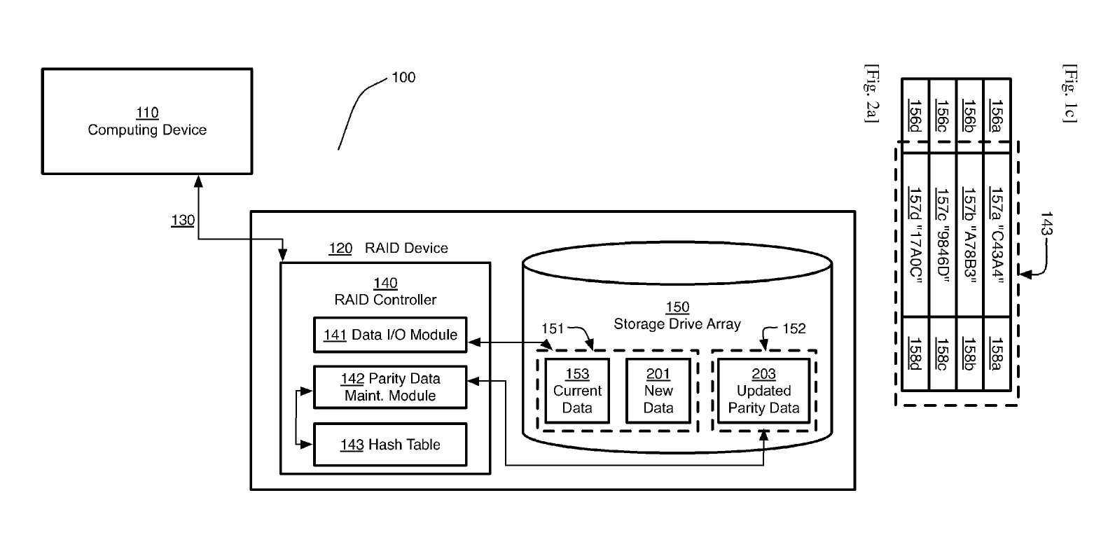

FIG. 1A illustrates a block diagram of an example system 100, arranged in accordance with at least some embodiments of the present disclosure. As can be seen from FIG. 1A, the system 100 may include a computing device 110 and a RAID device 120, communicatively coupled via connection 130. In some examples, the connection 130 may be an Internet connection, an optical connection, a LAN connection, a wireless connection, a PCIe connection, an eSATA connection, a USB connection, a Thunderbolt® connection, or any other suitable connection to transfer data between the computing device 110 and the RAID device 120. In some examples, the RAID device 120 and the computing device 110 may be enclosed in the same housing (e.g., enclosure, case, rack, or the like), including being integrated within or as a common electronic appliance. In some examples, the RAID device 120 and the computing device 110 may be enclosed in separate housings.

The RAID device 120 may include a RAID controller 140 and a storage drive array 150 operatively coupled to the RAID controller 140. In general, the storage drive array 150 may be comprised of any number of individual storage devices configured to act as a single logical storage device. In practice, the storage drive array 150 may be comprised of at least three individual storage drives. For example, the scenario above described a storage drive array including two data drives (e.g., the first individual storage device and the second individual storage device) and one parity drive (e.g., the third individual storage device). As another example, the storage drive array 150 may be comprised of four data drives and one parity drive. Various other example RAID configurations as well as methods to write data to the data drives in the storage drive array 150 were described above. Any practical number of example RAID configurations may be provided. As such, the balance of this disclosure assumes that the storage drive array 150 includes a data storage portion 151 and a parity data storage portion 152. No further intention is made to distinguish between the locations of the data storage portion 151 and the parity data storage portion 152 on individual storage devices. However, in practice, the data storage location 151 may be implemented across multiple individual storage devices (e.g., as described above with the first and second individual storage device). Similarly, the parity data storage location may be implemented across one or more individual storage devices.

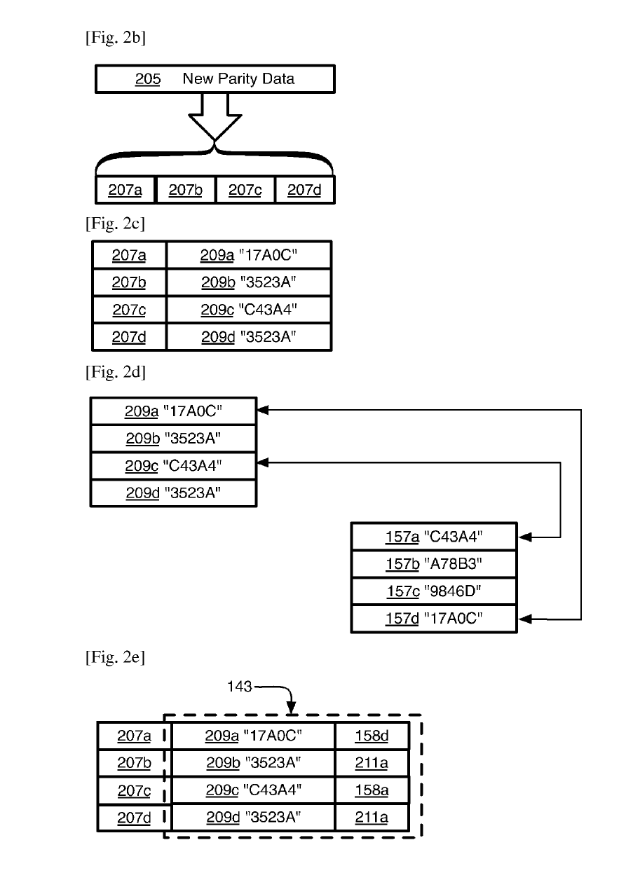

In general, the RAID controller 140 may be configured to provide read/write access to the RAID device 120. As shown, the RAID controller 140 may include a data input/output (I/O) module 141 configured to provide read and/or write access to the data storage portion 151 of the storage drive array 150. For example, the RAID controller 140 may receive data from the computing device 110, which is to be stored on the RAID device 120 and may cause the data to be stored in the data storage portion 151 using the data I/O module 141. As another example, the RAID controller 140 may receive, from the computing device 110, a request to read data from the RAID device 110 and may provide the data to the computing device 110 using the data I/O module 141. In some examples, the data may be a document, an image, a video, an archive file, or generally any digital file and/or data that may be stored on the storage drive array 150. For example, the data storage portion 151 including current data 153 and old data 154 is shown in FIG. 1A in a condition prior to receiving new data and prior to a parity data update as shown and described in FIG. 2A.

The RAID controller 140 may also include a parity data maintenance (maint.) module 142. In general, the parity data maintenance module 142 may be configured to implement an error protection scheme (e.g., the parity scheme described above). More particularly, the parity data maintenance module 142 may be configured to generate parity data based on data stored in the data storage portion 151. For example, the parity data maintenance module 142 may be configured to determine current parity data 155 based on an XOR operation between of the current data 153 and the old data 154. The parity data maintenance module 142 may also be configured to read and/or write parity data (e.g., the current parity data 155) to the parity data portion 152 of the storage drive array 150. The parity data maintenance module 142 may also be configured to rebuild the data storage portion 151 in the event of an error (e.g., data corruption, drive failure, or the like). For example, the parity data maintenance module 142 may be configured to recover the current data 153 based on an XOR operation between the current parity data 155 and the old data 154. Similarly, the parity data maintenance module 142 may be configured to recover the old data 154 based on an XOR operation between the current parity data 155 and the current data 153. In an example, data 1/O module 141 and/or parity data maintenance module 142 may be implemented in any of hardware, software, one or more blocks of executable code, a combination of hardware and software and the like or a combination thereof.

As part of generating the current parity data 155, the parity data maintenance module 142 may be configured to split the current parity data 155 into smaller pieces (e.g., chunks). For example, FIG. 1B shows the current parity data 155 split into four chunks 156a, 156b, 156c, and 156d, arranged in accordance with at least some embodiments of the present disclosure. The parity data maintenance module 142 may further be configured to generate a hash (e.g., Berkeley Software Distribution (BSD) checksum, Message-Digest Algorithm 2 (MD2), Message-Digest Algorithm 4 (MD4), Message-Digest Algorithm 5 (MD5), Message-Digest Algorithm 6 (MD6), or the like) corresponding to each chunk 156. For example, FIG. 1C shows the chunks 156a, 156b, 156c, and 156d as well as corresponding hash values 157a, 157b, 157c, and 157d, arranged in accordance with at least some embodiments of the present disclosure. FIG. 1C further shows pointers 158a, 158b, 158c, and 158d corresponding to the chunks 156a, 156b, 156c, and 156d respectively. In general, the pointers 158a-158d may include the location (e.g., address value, or the like) of corresponding chunks 156a-156d within the current parity data storage portion 152 of the storage drive array 150. For example, the pointer 158a may include an address value corresponding to the location of the chunk 156a of the current parity data 155 as stored in the parity data storage portion 152. The parity data maintenance module 142 may be configured to store the data comprising the hash values 157a-157d and the pointers 158a-158d in a hash table 143. For example, FIG. 1A shows the hash table 143. In some examples, like that shown in FIG. 1A, the hash table 143 may be stored in a memory location in the RAID controller 140. In other examples, the hash table 143 may be stored in storage drive array 150, for example in data storage portion 151 and/or parity data storage portion 152, in computing device 110, in a separate standalone device, a different RAID device and/or the like or a combination thereof.

As stated, the RAID controller 140 may receive new data from the computing device 110, which is to be stored in the RAID device 120. Accordingly, the data stored in the data storage portion 151 of the storage drive array 150 may change (e.g., when new and/or updated data is received from the computing device 110). For example, FIG. 2A shows the system 100 of FIG. 1A with current data 153 and new data 201 stored in the data storage portion 151 of the storage drive array 150, arranged in accordance with at least some embodiments of the present disclosure. As such, the current parity data 155 may be insufficient to provide fault tolerance of the data storage portion 151. More particularly, the parity data maintenance module 142 may not be able to recover either the current data 153 and/or the new data 201 based on the current parity data 155. The parity data maintenance module 142 may be configured to update the parity data storage portion 152 and the hash table 143, in response to a change in the data stored in the data storage portion 151.

In general, the parity data maintenance module 142 may be configured to determine new parity data based on the current data 153, the new data 201, and the current parity data 155. The parity data maintenance module 142 may also be configured to update the parity data storage portion 152 and the hash table 143 to correspond to the new parity data as described above (e.g., de-duplicate the new parity data). For example, in some embodiments, the parity data maintenance module 142 may determine new parity data as follows: temporary parity data may be determined based on an XOR operation between the current data 153 and the new data 201; new parity data may be determined based on an XOR operation between the current parity data 155 and the determined temporary parity data. FIG. 2B shows new parity data 205, which may be generated by the parity data maintenance module 142 as described above, arranged in accordance with at least some embodiments of the present disclosure. The parity data maintenance module 142 may also be configured to split the new parity data 205 into chunks. For example, FIG. 2B also shows the new parity data 205 split into chunks 207a, 207b, 207c, and 207d. The parity data maintenance module 142 may also be configured to determine hashes based on the chunks 207a-207d. For example, FIG. 2C shows the chunks 207a, 207b, 207c, and 207d and corresponding hash values 209a, 209b, 209c, and 209d respectively, arranged in accordance with at least some embodiments of the present disclosure. The parity data maintenance module 142 may also be configured to compare the hash values corresponding to the new parity data 205 (e.g., the hash values 209a-209d) to the hash values corresponding to the current parity data 155 (e.g., the hash values 157a-157d stored in the hash table 143). For example, FIG. 2D shows the hash values 209a-209d compared to the hash values 157a-157d, arranged in accordance with at least some embodiments of the present disclosure. As shown, the hash value 209a may be similar to the hash value 157d. Additionally, as shown, the hash value 209c may be similar to the hash value 157a.

The hash values identified to be similar may indicate that the corresponding chunks contain the same data. For example, the chunks 207a and 207c may contain the same data as chunks 156d and 156a corresponding to hash values 157d and 157a respectively. As such, the portions of the current parity data 155 (e.g., chunks) that correspond to portions (e.g., chunks) of the new parity data 205 may not need to be rewritten to the parity data storage portion 152. For example, the chunks 207a and 207c may not need to be written to the parity data storage portion 152 as they are already represented by the chunks 156d and 156a corresponding to hash values 157d and 157a respectively. Instead, the parity data maintenance module 142 may be configured to write one or more of chunks 207a-207d from the new parity data 205 that are not already stored in the parity data storage portion 152, for example chunks 207b and 207d, thereby forming updated parity data 203.

In addition to identifying chunks 207a-207d of the new parity data 205 that are duplicates of one or more chunks 156a-156d of the current parity data 155, the parity data maintenance module 142 may be configured to identify chunks 207a-207d of the new parity data 205 that have the same hash values 209a-209d. The parity data maintenance module 142 may be configured to write one of two or more chunks 207a-207d that are identified to be duplicates of each other. For example, FIG. 2C shows that the hash values 209b and 209d are the same. Accordingly, the chunks 207b and 207d may be duplicates of each other. As such, the parity data maintenance module 142 may be configured to write either the chunk 207b or 207d to the parity data storage portion 152.

The parity data maintenance module 142 may also be configured to update the hash table 143. For example, FIG. 2E shows the hash table 143 updated to correspond to the new parity data 205, arranged in accordance with at least some embodiments of the present disclosure. For example, FIG. 2E shows the chunks 207a-207d of the new parity data 205. Furthermore, the hash values 209a-209d are shown in the hash table 143. Additionally, the hash table shows pointers 158a, 158d and 211a. More particularly, using FIG. 2E as an example, the chunks 207a and 207c from the new parity data 205 are represented in the updated parity data 203 by the chunks 156d and 156a respectively. Accordingly, the pointers corresponding to the chunks 207a and 207c may be updated to correspond to the pointers (e.g., 158d and 158a) from the chunks 156d and 156a respectively. As both the chunks 207b and 207d may be represented in the updated parity data 203 by the same chunk (e.g., either 207b or 207d), their pointers (e.g., 211a) may be the same. In some examples, the parity data maintenance module 142 may write one or more of chunks 207a-207d of the new parity data 205 to the parity data storage portion 152 by overwriting one or more of chunks 156a-156d of the current parity data 155 (e.g., if the chunks 156a-156d are not duplicates of the chunks 207a-207d, or the like) to generate updated parity data 203. In some examples, the parity data maintenance module 142 may write one or more of chunks 207a-207d to unused space in the parity data storage portion 152 to generate updated parity data 203.

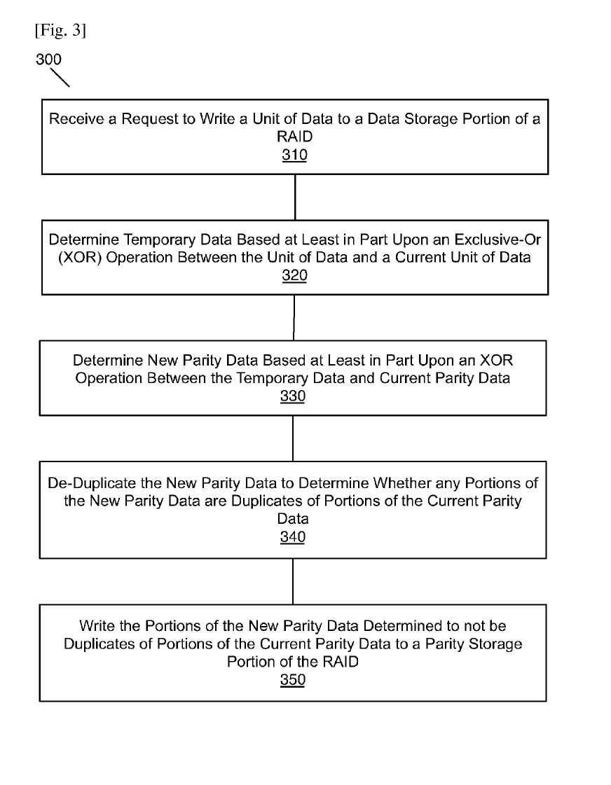

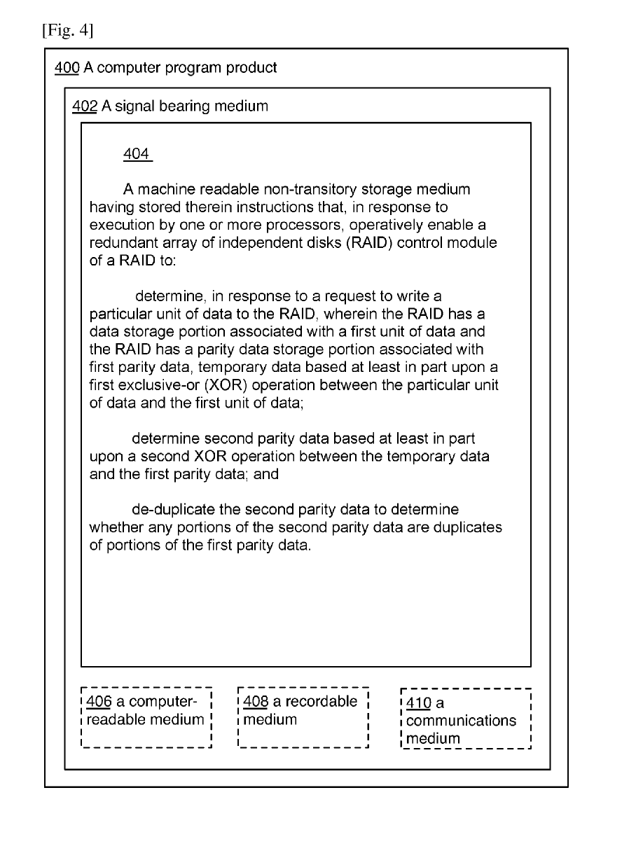

FIG. 3 illustrates a flow chart of an example method to maintain parity data for a RAID, arranged in accordance with at least some embodiments of the present disclosure. In some portions of the description, illustrative implementations of the methods depicted in FIG. 3 and elsewhere herein may be described with reference to the elements of the system 100 depicted in FIGS. 1A, 1B, 1C, 2A, 2B, 2C, 2D, and/or 2E. However, the described embodiments are not limited to this depiction. More specifically, some elements depicted in FIGS. 1A, 1B, 1C, 2A, 2B, 2C, 2D, and/or 2E may be omitted from some implementations of the methods detailed herein. Furthermore, other elements not depicted in FIGS. 1A, 1B, 1C, 2A, 2B, 2C, 2D, and/or 2E may be used to implement example methods detailed herein.

Additionally, FIG. 3 employs block diagrams to illustrate the example methods detailed therein. These block diagrams may set out various functional blocks or actions that may be described as processing steps, functional operations, events and/or acts, etc., and may be performed by hardware, software, and/or firmware. Numerous alternatives to the functional blocks detailed may be practiced in various implementations. For example, intervening actions not shown in the figures and/or additional actions not shown in the figures may be employed and/or some of the actions shown in the figures may be eliminated, modified, or split into multiple actions. In some examples, the actions shown in one figure may be operated using techniques discussed with respect to another figure. Additionally, in some examples, the actions shown in these figures may be operated using parallel processing techniques. The above described, and other not described, rearrangements, substitutions, changes, modifications, etc., may be made without departing from the scope of claimed subject matter.

FIG. 3 illustrates an example method 300 to maintain parity data for a RAID device, arranged in accordance with various embodiments of the present disclosure. Method 300 may begin at block 310 “Receive a Request to Write a Unit of Data to a Data Storage Portion of a RAID,” a RAID controller may include logic and/or features configured to receive data to be written to a RAID device. For example, the RAID controller 140 may receive data from the computing device 110 that is to be written to the RAID device 120. In general, at block 310, the RAID controller 140 may receive (e.g., via the connection 130) data from the computing device 110.

Processing may continue from block 310 to block 320 “Determine Temporary Data Based at Least in Part Upon an Exclusive-Or (XOR) Operation Between the Unit of Data and a Current Unit of Data,” the RAID controller may include logic and/or features configured to determine temporary data based on an XOR operation between the unit of data and a current unit of data. For example, the parity data maintenance module 142 of the RAID controller 140 may determine temporary data based on an XOR operation between the current data 153 and new data 201.

Processing may continue from block 320 to block 330 “Determine New Parity Data Based at Least in Part Upon an XOR Operation Between the Temporary Data and Current Parity Data,” the RAID controller may include logic and/or features configured to determine new parity data based on an XOR operation between the temporary data and the current parity data. For example, the parity data maintenance module 142 of the RAID controller 140 may determine new parity data 205 based on an XOR between the temporary data and the current parity data 155.

Processing may continue from block 330 to block 340 “De-Duplicate the New Parity Data to Determine Whether any Portions of the New Parity Data are Duplicates of Portions of the Current Parity Data,” the RAID controller may include logic and/or features configured to de-duplicate the new parity data to determine whether portions of the new parity data are duplicates of portions of the current parity data. For example, the parity data maintenance module 142 of the RAID controller 140 may de-duplicate the new parity data 205. In general, at block 340, the parity data maintenance module 142 may split the new parity data 205 into chunks 207a-207d and generate hash values 209a-209d for each chunk 207a-207d. The parity data maintenance module 142 of the RAID controller 140 may then compare hash values 209a-209d to the bash values 157a-157d stored in the hash table 143 to determine whether any chunks 207a-207d of the new parity data 205 are duplicates of chunks 156a-156d. In some examples, the hash values 209a-209d may also be processed to determine if any chunks 207a-207d are duplicates of another chunk 207a-207d.

Processing may continue from block 340 to block 350 “Write the Portions of the New Parity Data Determined to not be Duplicates of Portions of the Current Parity Data to a Parity Storage Portion of the RAID,” the RAID controller may include logic and/or features configured to write portions of the new parity data determined to not be duplicates of one or more portions of the current parity data to a parity data storage portion of the RAID. For example, the parity data maintenance module 142 of the RAID controller 140 may write one or more chunks 207a-207d determined to not be duplicates of one or more chunks 156a-156d to the parity data storage portion 152.

Additionally, at block 340 and/or block 350, the RAID controller may include logic and/or features configured to update a hash table based in part upon the de-duplication of block 340. For example, the parity data maintenance module 142 may update the hash table 143 based on de-duplicating the new parity data 205.

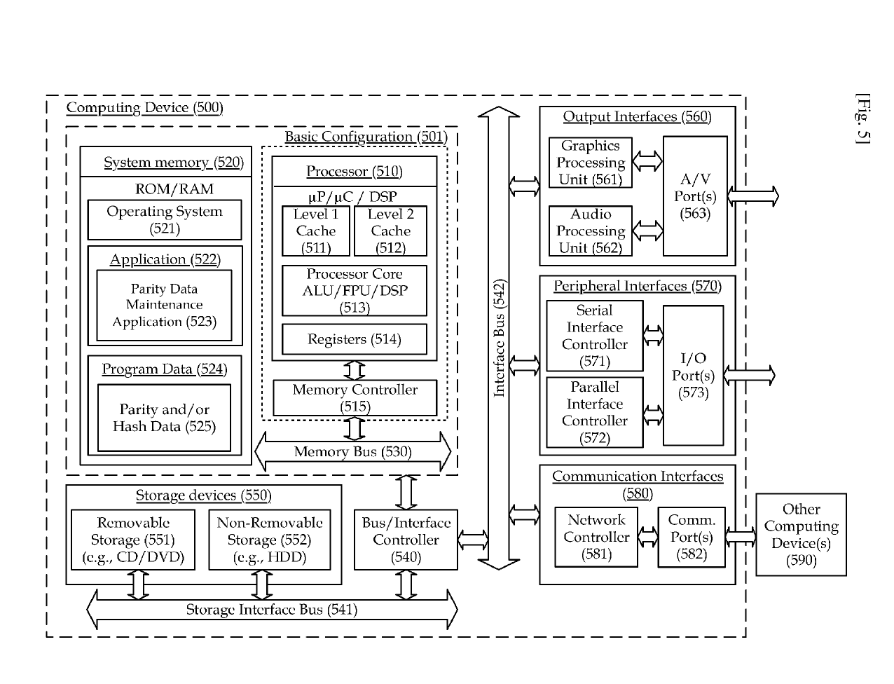

In one embodiment, the methods described with respect to FIG. 3 and elsewhere herein may be implemented as a computer program product, executable on any suitable computing system, or the like. Example computer program products may be described with respect to FIG. 4, and elsewhere herein.

FIG. 4 illustrates an example computer program product 400, arranged in accordance with at least some embodiments of the present disclosure. Computer program product 400 may include machine-readable non-transitory medium having stored therein instructions that, in response to execution (for example by a processor), cause a RAID control module to maintain parity data in a RAID as discussed herein. Computer program product 400 may include a signal bearing medium 402. Signal bearing medium 402 may include one or more machine-readable instructions 404, which, in response to execution by one or more processors, may operatively enable a computing device to provide the features described herein. In various examples, the devices discussed herein may use some or all of the machine-readable instructions.

In some examples, the machine-readable instructions 404 may include detecting a request to write a unit of data to a data storage portion of the RAID that has a current unit of data stored in the data storage portion and has current parity data stored in a parity data storage portion of the RAID. In some examples, the machine-readable instructions 404 may include determining, in response to the request to write the unit of data, temporary data based at least in part upon an exclusive-or (XOR) operation between the unit of data and the current unit of data. In some examples, the machine-readable instructions 404 may include determining new parity data based at least in part upon an XOR operation between the temporary data and the current parity data. In some examples, the machine-readable instructions 404 may include de-duplicating the new parity data to determine whether any portions of the new parity data are duplicates of portions of the current parity data. In some examples, the machine-readable instructions 404 may include writing the portions of the new parity data determined to not be duplicates of the portions of the current parity data to the parity data storage portion of the RAID.

In some implementations, signal bearing medium 402 may encompass a computer-readable medium 406, such as, but not limited to, a hard disk drive, a Compact Disc (CD), a Digital Versatile Disk (DVD), a digital tape, memory, etc. In some implementations, the signal bearing medium 402 may encompass a recordable medium 408, such as, but not limited to, memory, read/write (R/W) CDs, R/W DVDs, etc. In some implementations, the signal bearing medium 402 may encompass a communications medium 410, such as, but not limited to, a digital and/or an analog communication medium (e.g., a fiber optic cable, a waveguide, a wired communication link, a wireless communication link, etc.). In some examples, the signal-bearing medium 402 may encompass a machine-readable non-transitory medium.

In general, the methods described with respect to FIG. 3 and elsewhere herein may be implemented in any suitable server and/or computing system and/or other electronic device(s). Example systems may be described with respect to FIG. 5 and elsewhere herein. In some examples, a RAID device, or other system as discussed herein may be configured to maintain parity data for a RAID.

FIG. 5 is a block diagram illustrating an example computing device 700, arranged in accordance with at least some embodiments of the present disclosure. In various examples, computing device 500 may be configured to maintain parity data for a RAID as discussed herein. In one example of a basic configuration 501, computing device 500 may include one or more processors 510 and a system memory 520. A memory bus 530 can be used for communicating between the one or more processors 510 and the system memory 520.

Depending on the desired configuration, the one or more processors 510 may be of any type including but not limited to a microprocessor (μP), a microcontroller (μC), a digital signal processor (DSP), or any combination thereof. The one or more processors 510 may include one or more levels of caching, such as a level one cache 511 and a level two cache 512, a processor core 513, and registers 514. The processor core 513 can include an arithmetic logic unit (ALU), a floating point unit (FPU), a digital signal processing core (DSP core), or any combination thereof. A memory controller 515 can also be used with the one or more processors 510, or in some implementations the memory controller 515 can be an internal part of the processor 510.

Depending on the desired configuration, the system memory 520 may be of any type including but not limited to volatile memory (such as RAM), non-volatile memory (such as ROM, flash memory, etc.) or any combination thereof. The system memory 520 may include an operating system 521, one or more applications 522, and program data 524. The one or more applications 522 may include parity data maintenance application 523 that can be arranged to perform the functions, actions, and/or operations as described herein including any of the functional blocks, actions, and/or operations described with respect to FIGS. 1-4 herein. The program data 524 may include parity and/or hash data 525 for use with parity data maintenance application 523. In some example embodiments, the one or more applications 522 may be arranged to operate with the program data 524 on the operating system 521. This described basic configuration 501 is illustrated in FIG. 5 by those components within dashed line.

Computing device 500 may have additional features or functionality, and additional interfaces to facilitate communications between the basic configuration 501 and any required devices and interfaces. For example, a bus/interface controller 540 may be used to facilitate communications between the basic configuration 501 and one or more data storage devices 550 via a storage interface bus 541. The one or more data storage devices 550 may be removable storage devices 551, non-removable storage devices 552, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

The system memory 520, the removable storage 551 and the non-removable storage 552 are all examples of computer storage media. The computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 542 for facilitating communication from various interface devices (e.g., output interfaces, peripheral interfaces, and communication interfaces) to the basic configuration 501 via the bus/interface controller 540. Example output interfaces 560 may include a graphics processing unit 561 and an audio processing unit 562, which may be configured to communicate to various external devices such as a display or speakers via one or more A/V ports 563. Example peripheral interfaces 570 may include a serial interface controller 571 or a parallel interface controller 572, which may be configured to communicate with external devices such as input devices (e.g., keyboard, mouse, pen, voice input device, touch input device, etc.) or other peripheral devices (e.g., printer, scanner, etc.) via one or more I/O ports 573. An example communication interface 580 includes a network controller 581, which may be arranged to facilitate communications with one or more other computing devices 583 over a network communication via one or more communication ports 582. A communication connection is one example of a communication media. The communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR) and other wireless media. The term computer readable media as used herein may include both storage media and communication media.

The computing device 500 may be implemented as a portion of a small-form factor portable (or mobile) electronic device such as a cell phone, a mobile phone, a tablet device, a laptop computer, a personal data assistant (PDA), a personal media player device, a wireless web-watch device, a personal headset device, an application specific device, or a hybrid device that includes any of the above functions. The computing device 500 may also be implemented as a personal computer including both laptop computer and non-laptop computer configurations. In addition, the computing device 500 may be implemented as part of a wireless base station or other wireless system or device.

Some portions of the foregoing detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing device, that manipulates or transforms data represented as physical electronic or magnetic quantities within memories, registers, or other information storage devices, transmission devices, or display devices of the computing device.

The claimed subject matter is not limited in scope to the particular implementations described herein. For example, some implementations may be in hardware, such as employed to operate on a device or combination of devices, for example, whereas other implementations may be in software and/or firmware. Likewise, although claimed subject matter is not limited in scope in this respect, some implementations may include one or more articles, such as a signal bearing medium, a storage medium and/or storage media. This storage media, such as CD-ROMs, computer disks, flash memory, or the like, for example, may have instructions stored thereon, that, when executed by a computing device, such as a computing system, computing platform, or other system, for example, may result in execution of a processor in accordance with the claimed subject matter, such as one of the implementations previously described, for example. As one possibility, a computing device may include one or more processing units or processors, one or more input/output devices, such as a display, a keyboard and/or a mouse, and one or more memories, such as static random access memory, dynamic random access memory, flash memory, and/or a hard drive.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be affected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a flexible disk, a hard disk drive (HDD), a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to subject matter containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of“two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Reference in the specification to “an implementation,” “one implementation,” “some implementations,” or “other implementations” may mean that a particular feature, structure, or characteristic described in connection with one or more implementations may be included in at least some implementations, but not necessarily in all implementations. The various appearances of“an implementation,” “one implementation,” or “some implementations” in the preceding description are not necessarily all referring to the same implementations.

While certain example techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

1. A method to maintain parity data in a redundant array of independent disks (RAID), the method comprising:
at a RAID control module, receiving a request to write a unit of data to the RAID,
wherein the RAID has a data storage portion associated with a current unit of data, and
wherein the RAID has a parity data storage portion associated with a current parity data; and
in response to the request to write the unit of data to the RAID:
determining temporary data based at least in part upon a first exclusive-or (XOR) operation between the unit of data and the current unit of data;
determining new parity data based at least in part upon a second XOR operation between the temporary data and the current parity data; and
de-duplicating the new parity data to determine whether any one or more portions of the new parity data are duplicates of one or more portions of the current parity data.

2. The method of claim 1, further comprising:
writing portions of the new parity data determined to be non-duplicative to the parity data storage portion of the RAID.

3. The method of claim 1, further comprising:
chunking the new parity data prior to de-duplicating the new parity data.

4. The method of claim 3, wherein:
data in the data storage portion of the RAID is organized into pages,
the new parity data has a first size substantially similar to one of the pages, and
chunking the new parity data comprises splitting the new parity data into one or more chunks, each chunk having a second size that is less than or equal to the first size.

5. The method of claim 4, wherein splitting the new parity data into one or more chunks includes splitting the new parity data such that the second size is 4 kilobytes.

6. The method of claim 1, wherein de-duplicating the new parity data comprises:
determining a first hash value that corresponds to the new parity data;
comparing the first hash value to a second hash value, wherein the second hash value corresponds to the current parity data; and
identifying, based on the comparison, the one or more portions of the new parity data that are duplicates of the one or more portions of the current parity data.

7. The method of claim 3, wherein de-duplicating the new parity data comprises:
for each chunk of the new parity data:
determining a first hash value that corresponds to the chunk;
comparing first hash values to second hash values stored in a hash table, wherein the second hash values stored in the bash table correspond to chunks of the current parity data; and
identifying, based on the comparison, the chunk as non-duplicative of one or more chunks of the current parity data.

8. The method of claim 7, wherein de-duplicating the new parity data further comprises, for each chunk of the new parity data:
writing the chunk identified to be non-duplicative of the one or more chunks of the current parity data to the parity data storage portion of the RAID.

9. The method of claim 7, wherein:
the hash table includes indicators for each chunk of the current parity data, the indicators being associated with locations of the chunks in the parity data storage portion of the RAID, and
de-duplicating the new parity data further comprises:
identifying, based on the comparison, one or more chunks of the new parity data that are duplicates of one or more chunks of the current parity data;
updating the first hash values in the hash table for the one or more chunks of the new parity data that are identified as non-duplicative of one or more chunks of the current parity data; and
updating the indications in the hash table for the one or more chunks of the new parity data that are identified as duplicative of one or more chunks of the current parity data,
wherein updating the indications in the hash table is based at least in part upon writing the chunks of the new parity data identified to be non-duplicative of one or more chunks of the current parity data to the parity data storage portion of the RAID.

10. A machine readable non-transitory storage medium having stored therein instructions that, in response to execution by one or more processors, operatively enable a redundant array of independent disks (RAID) control module of a RAID to:
determine, in response to a request to write a particular unit of data to the RAID, temporary data based at least in part upon a first exclusive-or (XOR) operation between the particular unit of data and a first unit of data,
wherein the RAID has a data storage portion associated with the first unit of data, and
wherein the RAID has a parity data storage portion associated with first parity data;
determine second parity data based at least in part upon a second XOR operation between the temporary data and the first parity data; and
de-duplicate the second parity data to determine whether any one or more portions of the second parity data are duplicates of one or more portions of the first parity data.

11. The machine readable non-transitory medium of claim 10, wherein the stored instructions, in response to execution by the one or more processors, further operatively enable the RAID control module to;
write portions of the second parity data determined to be non-duplicative of portions of the first parity data.

12. The machine readable non-transitory medium of claim 10, wherein the stored instructions, in response to execution by the one or more processors, further operatively enable the RAID control module to:
chunk the second parity data prior to de-duplication of the second parity data.

13. The machine readable non-transitory medium of claim 12, wherein:
data in the data storage portion of the RAID is organized into pages,
the second parity data has a first size substantially similar to one of the pages, and
the stored instructions that operatively enable the RAID control module to chunk the second parity data include instructions that, in response to execution by the one or more processors, operatively enable the RAID control module to:
split the second parity data into one or more chunks, wherein each chunk has a second size that is less than or equal to the first size.

14. The machine readable non-transitory medium of claim 13, wherein
the stored instructions that operatively enable the RAID control module to split the second parity data include instructions that, in response to execution by the one or more processors, operatively enable the RAID control module to:
split the second parity data into one or more chunks such that the second size is 4 kilobytes.

15. The machine readable non-transitory medium of claim 10, wherein the stored instructions that operatively enable the RAID control module to de-duplicate the second data include instructions that, in response to execution by the one or more processors, operatively enable the RAID control module to:
determine a first hash value that corresponds to the second parity data;
compare the first hash value to a second hash value, wherein the second hash value corresponds to the first parity data; and
identify, based on the comparison, portions of the second parity data that are duplicates of portions of the first parity data.

16. The machine readable non-transitory medium of claim 10, wherein
the stored instructions, in response to execution by one or more processors, further operatively enable the RAID control module to:
compare second parity data chunks with first parity data chunks,
wherein the second parity data chunks include a portion of the second parity data, and
wherein each of the first parity data chunks include a portion of the first parity data;
determine whether the second parity data chunks are duplicative of any of the first parity data chunks based on the comparison;
in response to the second parity data chunks being duplicative of t first parity data chunks:
identify a location in the parity data storage portion of the RAID of the first parity data chunks; and
assign the location to the second parity data chunks; and
in response to the second parity data chunks being non-duplicative of the first parity data chunks, assign a new location in the parity data storage portion of the RAID to the second parity data chunks.

17. The machine readable non-transitory medium of claim 16, wherein the stored instructions, in response to execution by one or more processors, further operatively enable the RAID control module to:
compare the second parity data chunks with different second parity data chunks that each comprise other portions of the second parity data;
determine whether the second parity data chunks are duplicative of any of the different second parity data chunks based on the comparison;
in response to the second parity data chunks being duplicative of a different second parity data chunk of the different second parity data chunks, assign a same location in the parity data storage portion of the RAID to the second parity data chunks and the different second parity data chunk; and
in response to the second parity data chunks being non-duplicative to the different second parity data chunks, assign different locations in the parity data storage portion of the RAID to the second parity data chunks and the different second parity data chunks.

18. The machine readable non-transitory medium of claim 16 wherein the stored instructions, in response to execution by one or more processors, further operatively enable the RAID control module to:
write third parity data to the parity data storage portion of the RAID that comprises the second parity data chunks and that is assigned to the new location.

19. A system, comprising:
a redundant array of independent disks (RAID),
wherein the RAID has a data storage portion associated with a current unit of data, and
wherein the RAID has a parity data storage portion associated with a current parity data; and
a RAID control module communicatively coupled to the RAID, the RAID control module comprising:
a data input/output (I/O) module configured to receive a request to write a unit of data to the RAID;
a parity data maintenance module configured to:
compare, in response to the request to write the unit of data, the unit of data with the current parity data to identify temporary parity data;
compare the temporary parity data with the current parity data to identify new parity data;
split the new parity data into new parity data chunks;
build a hash table that associates each first hash value with different ones of the new parity data chunks and that associates each of second hash values with different ones of chunks of the current parity data;
identify a non-duplicative chunk of the new parity data that comprises at least a first portion of the unit of data based on a comparison of the first hash values with the second hash values; and
associate, in the hash table, a new location pointer to a new location in the parity data storage portion of the RAID with an identifier of the non-duplicative chunk of the new parity data so as to update the hash table.

20. The system of claim 19, wherein the parity data maintenance module is further configured to:
identify a duplicative chunk of the new parity data that comprises at least a second portion of the unit of data based on the comparison of the first hash values with the second hash values.

21. The system of claim 19, wherein the data I/O module is further configured to write the non-duplicative chunk of the new parity data to the parity data storage portion of the RAID.

22. (canceled)

23. The system of claim 20, wherein the parity data maintenance module is further configured to;
associate, in the hash table, a current location pointer to a current location in the parity data storage portion of the RAID with an identifier of the duplicative chunk of the new parity data so as to update the hash table, wherein the current location pointer is associated with a second hash value of the second hash values.

24. The system of claim 19, wherein the parity data maintenance module is further configured to:
identify duplicative chunks of the new parity data, wherein the new parity data comprises two or more of: the first portion of the unit data, a second portion of the unit data, and a third portion of the unit of data, based on a comparison of each of the first hash values with others of the first hash values.

25. The system of claim 24, wherein the parity data maintenance module is further configured to:
associate, in the hash table, a same location pointer to a same location in the parity data storage portion of the RAID with each identifier of the duplicative chunks of the new parity data so as to update the hash table.

26. The system of claim 19, wherein the parity data maintenance module is further configured to update the parity data storage portion of the RAID based on the updated hash table.

27. The system of claim 23, wherein the parity data maintenance module is further configured to update the parity data storage portion of the RAID based on the updated hash table.

28. (canceled)
